(19) United States
(12) Patent Application Publication
(10) Pub. No.: US 2024/0225306 A9
(43) Pub. Date: Jul. 11, 2024

(54) PRODUCT PRESENTATION DEVICE WITH A STORAGE STRUCTURE FOR PLACING OBJECTS AND WITH A SENSOR FOR DETECTING INVENTORY

(71) Applicant: Captana GmbH, Ettenheim (DE)

(72) Inventors: Thomas Schwarz, Hohberg (DE); Michael Unmüssig, Ettenheim (DE)

(21) Appl. No.: 18/556,687

(22) PCT Filed: Apr. 23, 2021
(86) PCT No.: PCT/EP2021/060710

§ 371 Date: Oct. 23, 2023

(51) Int. Cl. A47F 1/12; A47F 5/00; A47F 10/02

(52) U.S. Cl. CPC A47F 1/125; A47F 5/0025; A47F 5/0062; A47F 10/02; A47F 2010/025

(57) ABSTRACT

Product presentation device comprising: at least one sensor with a detection area for detecting an object within the detection area, in particular, by measuring the distance between the sensor and the object, and at least one storage structure for storing the object, wherein the storage structure comprises a rear edge and a front edge, wherein the detection area of the sensor is orientated along the direction from the rear edge to the front edge, wherein
either a) a sensor movement system is provided in accordance with the embodiment type, by means of which a sensor can be moved at least along the rear edge,
or in accordance with the embodiment type b), individually positioned sensors are provided along the rear edge and, corresponding to the position of the respective sensor, a product guidance structure is provided which is provided to guide the object towards the front edge, wherein the product guidance structure is designed in such a way that either the product guidance structure can be directly detected by the respective sensor or the direct detection of the guided object by the sensor is made possible,
or, in accordance with the embodiment type c), a sensor movement system is provided, by means of which a sensor can be moved at least along the rear edge, and a product guidance structure is provided which is provided to guide the object towards the front edge, wherein the product guidance structure is designed in such a way that either the product guidance structure can be directly detected by the respective sensor or the direct detection of the guided object by the sensor is made possible
or, in accordance with an embodiment type d), at least one sensor, or optionally, also at least one product guidance structure in accordance with the embodiment type c) is provided along the rear edge, wherein at least one sensor comprises a variable opening angle of its detection area.

### TECHNICAL FIELD

Product presentation device with a storage structure for placing objects and with a sensor for detecting inventory.

### Background

From DE102017104041A1, a product presentation device for feeding goods forward is known. The product presentation device comprises a compartment for storing a plurality of goods, wherein one or a plurality of goods can be removed from the compartment at a removal area, and, on the side opposite to the removal area, a slider pre-tensioned by a spring rests against one of the goods, and is moved in the feed direction when a product is removed, wherein a sensor is provided for detecting inventory, and wherein a motion sensor is arranged on the slider, by means of which motion of the slider can be detected in order to take at least one measurement to detect inventory when the slider moves.

This device has proven to be unfavourable because many such devices with many moving sensors are needed to detect the inventory of a shelf. A shelving system that uses such devices is therefore very complex and expensive due to the presence of a plurality of sensors moving in an uncoordinated manner and the respective mechanical system required for this.

If more such devices are used, not only the complexity of the system increases but also the number of components required, resulting in an increase in costs for the system, this increase being at least linearly with the number of devices used. The device or system that uses these devices is therefore poorly scalable.

The object of the invention therefore relates to providing an improved product presentation device in which the problems described above are overcome.

### SUMMARY OF THE INVENTION

This task is solved by means of a product presentation device according to claim 1. The object of the invention therefore entails a product presentation device comprising: at least one sensor with a detection area for detecting an object within the detection area, in particular, by measuring the distance between the sensor and the object, and at least one storage structure for storing the object, wherein the storage structure comprises a rear edge and a front edge, wherein the detection area of the sensor is orientated along the direction from the rear edge towards the front edge, wherein
either in accordance with an embodiment type: a) a sensor movement system is provided by means of which a sensor can be moved along the rear edge,
or in accordance with an embodiment type b) individually positioned sensors are provided along the rear edge and, corresponding to the position of the respective sensor, a product guidance structure is provided, which is provided for guiding the object towards the front edge, wherein the product guidance structure is designed in such a way that either the product guidance structure can be directly detected by the respective sensor, or the direct detection of the guided object is made possible by the sensor,
or, in accordance with an embodiment type c), a sensor movement system is provided, by means of which a sensor can be moved along the rear edge, and a product guidance structure is provided, which is provided to guide the object towards the front edge, wherein the product guidance structure is designed in such a way that either the product guidance structure can be directly detected by the respective sensor or the direct detection of the guided object is made possible by the sensor,
or, in accordance with an embodiment type d), at least one sensor, optionally also at least a product guidance structure in accordance with the embodiment type c), is provided along the rear edge, wherein at least one sensor comprises a variable opening angle of its detection area.

The measures according to the invention are therefore accompanied by the advantage that the positioning of the sensor at the rear edge of the storage structure or adjacent to the rear edge enables a significantly simplified implementation of the product presentation device.

For example, in the embodiment type in accordance with point a), only a single sensor movement system is required to detect objects with only a single sensor or also a plurality of sensors moved with it.

Furthermore, in the embodiment type in accordance with point b), no sensor movement system is necessary at all in order to carry out the detection of objects with a plurality of sensors permanently positioned corresponding to product guidance structures.

Furthermore, in the embodiment type in accordance with point c), despite the existence of the product guidance structure, only a single sensor or a smaller number of sensors is required as product guidance structures in order to carry out detection.

Furthermore, in the case of the embodiment type in accordance with point d), it is precisely achieved with the aid of the adjustable opening angle that it can be adapted to the conditions of the target placement of the objects or groups of objects. Thereby, for example, with only a linear placement of objects of the same group along the direction from the rear edge to the front edge, a narrow opening angle can be selected or set in order to detect these objects. In addition, in the case of placing objects of the same group, which can be successively placed one after the other as well as next to each other, into the width, i.e., perpendicular to the direction from the rear edge to the front edge—an additional opening angle can also be selected or set. This means that narrow storage structures or narrow product guidance structures, as well as wider storage structures or wider product guidance structures can be checked to see whether there are any products present there or whether there are no more products present there.

In a preferred embodiment, the width of the opening angle of the detection area can be set in a software-based manner. For this purpose, the sensor can be equipped, for example, with an optoelectronic detection system that comprises an optical lens configuration (one or a plurality of lenses, possibly even with an autofocus function) and an adjacent sensor array, on which the lens configuration maps an image of the detected environment. Via software-based selective activation (inclusion) or deactivation (omission) of elements of the sensor array (particularly the peripheral areas) during detection, the opening angle can be adapted to the respective scene to be detected.

Depending on the requirements, the width of the opening angle can be ring-shaped or also be changeable running along a function, or it can be set individually in different directions, i.e., independently of each other. For example, a first width of the opening angle on the plane or parallel to the plane of the storage structure can vary from sensor to sensor and be adapted to the individual object sizes to be detected or also their grouping, generally their storage spaces or the extent of the storage spaces. In contrast, for all installed sensors or at least for a group of these sensors, a second width of the opening angle can be set identically on a plane transverse to the plane of the storage structure. This means that areas of different widths in a shelf can be monitored by different sensors, whereas the distance between shelves does not flow into the detection because the shelves are not detected due to the relatively small (narrow) second width.

For the sake of completeness, it should already be mentioned at this point that all embodiment types a), b) and c) described above can be equipped with a sensor at a variable opening angle to the detection area.

The device is therefore excellently scalable due to reducing down to the sensor equipment that is absolutely necessary at the rear edge or adjacent to it. In particular, due to the placement of the sensors only on the rear edge or adjacent to this rear edge, no consideration must be given to the sensors when placing the objects.

The product presentation device can be implemented as a stand-alone device, which is placed on a shelf for example. However, the product presentation device can also form a row of shelves or a shelf floor or an entire shelf.

The detection area of the sensor can differ depending on the type of sensor and embodiment and, for example, be linear, cylindrical, cone-shaped or also club-shaped but can be modelled software-based, particularly with regard to its width, as described above. The orientation of the detection area of the sensor is always, i.e., in all embodiment types in accordance with point a) to point d), orientated from the sensor to the front edge so that an object between the rear edge and the front edge can be detected.

In principle, the task of the sensor can be limited to only determining whether an object is present or not present within its detection area. This can be used to determine whether the storage structure is empty or whether there are still one or a plurality of objects on the storage structure. However, if the inventory is to be detected on the storage structure, it has proven to be particularly favourable that the sensor is designed to measure the distance between the sensor and the object. The distance measurement can be used to infer the number of objects in the storage structure by knowing the dimensions of the objects. In general, it should already be mentioned at this point that the distance measurement can also be based on the detection of a change in position of the detected object or also a speed or acceleration that is determined in connection with the object.

The object can be a product or a good as such.

The storage structure can be, for example, a shelf or also a sales table for the presentation of objects.

The rear and front edges form the demarcation of the storage area in which one or a plurality of objects are placed. Also, in front of the front edge or behind the rear edge, there can be other structural elements of the product presentation device with other tasks. For example, there can be a shelf rail for attaching shelf labels in front of the front edge and a fastening or support structure can be provided behind the rear edge.

For example, the sensor movement system in accordance with embodiment type a) can be designed in such a way that it moves only one sensor or a number of sensors along the rear edge of the storage structure and in doing so, i.e., during movement, the sensor detects it. The detection can essentially be quasi-continuous or carried out from there at different discrete positions. For example, when using the product presentation device as part of a shelf or as a shelf, the inventory of a shelf can be detected with only one sensor or a small number of sensors. Furthermore, the sensor movement system can also be designed in such a way that it enables the previously described movement for a single sensor or a group of sensors along the rear edge of a number of storage structures, which can be arranged, for example, next to each other and/or also on top of each other.

Further particularly favourable embodiments and further embodiments of the invention result from the dependent claims as well as the following description.

The product presentation device or the attachment of the sensor to it can be designed in such a way that the detection area of the sensor can essentially only detect a small area of the storage structure, and therefore, the sensor can only be used to check whether an object or part of the product guidance structure is present in this area. The detection of such a small area is sufficient, for example, to determine whether the storage structure is presumably filled with objects up to its rear edge, or whether there is a deviating inventory level.

In order to obtain more information about the number or quantity of objects in the storage structure, it has proven to be favourable if the product presentation device is designed in such a way that a larger area of the storage structure, particularly from its rear edge to its front edge, can be detected through which at least one sensor can be detected.

It is therefore favourable if the storage structure comprises a slope that deviates from the horizontal, and the sensor is orientated in such a way that its detection area essentially follows the inclination of the storage structure. Only this alignment of the detection area of the sensor, which essentially follows the orientation of the storage structure, ensures unhindered detection of objects along the storage structure from their rear edge to their front edge. This forms the basis for reliable inventory detection. The orientation of the detection area of the sensor in relation to the orientation of the storage structure can be adjusted or defined, for example, by the inclination at which the sensor is mounted or by the internal structure of the sensor, such as its variably adjustable opening angle.

The inclination of the storage structure can be selected in such a way that, when an object is removed, the objects behind or above it or an object behind or above it slips or slides forward or rolls along after.

The at least one sensor can be designed in different ways for direct or indirect distance measurement (as mentioned, via speed or acceleration measurement and reverse calculation). For example, the sensor can also be designed in such a way that a distance measurement can be carried out with it via triangulation.

Preferably, however, the sensor is designed to measure time of flight. By measuring the time of flight of a signal emitted by it (radio or light), the distance to an object or object reflecting the signal is determined.

The use of a sensor designed for time-of-flight measurement allows a defined design of the detection area, which can even be essentially linear and thus orientated as precisely as possible.

As it is detected, the sensor generates detection data that preferentially represents the distance between the sensor and the detected object or item.

The sensor can transmit or deliver its detection data via cable. A plurality of sensors of a product presentation device or also a plurality of sensors of a plurality of product presentation devices can also transmit their detection data via cable to a separate radio module, wherein this radio module is designed to forward the detection data wirelessly. The radio module thus transmits the detection data of a group of sensors from one or various product presentation devices. Such a group can be formed, for example, of the product presentation devices, each of which forms a row of shelves, or of product presentation devices, each of which is located in a row of shelves or on a shelf.

In accordance with a preferred embodiment type, the sensor is designed to transmit its detection data, which represents the detection of the object using radio-based transmission. Preferably, the sensor itself comprises an (integrated) radio module.

This generally allows easy and flexible installation and maintenance of the product presentation device because there is no need to lay cables that would connect the sensor to an external radio module.

Particularly when using a sensor movement system, complex cable routing, for example, by means of an energy supply chain, can be dispensed with, which means that the device can be dimensioned slimmer and is also less prone to errors.

The processing of the detection data can be carried out externally after it has been transferred to an external processing device. Analogous to the separate radio module, the external processing device can also process the detection data of a group of sensors. Of course, the external processing device can also be designed to control the sensor(s) or also to exchange data other than the detection data with the sensors. For example, setting data for adjusting the width of the opening angle can also be transmitted.

However, the processing of the detection data can also take place in an internal processing module of the sensor, after which detection data already pre-processed by the sensor is delivered.

The internal radio module can be designed to deliver the detection data as raw data or pre-processed, for example, via a wireless local area network (WLAN/WIFI) or via a mesh network configuration. Other de facto standardized communication protocols such as ZigBee or Bluetooth can also be used. It can also be provided that the sensors are equipped with a 4G- or 5G-radio module in order to handle their radio traffic via a (public) mobile network and to act as IoT devices (IoT stands for Internet of Things). A separate 4G- or 5G-capable radio can also serve as an access point for the sensors that are connected to this access point via radio or cable. Of course, other devices that are part of the infrastructure of a merchandise management system or a shelf logistics system can also serve as an IoT hub for the sensors. For this purpose, for example, cameras can be used to film shelves. These cameras have 4G- or 5G-cellular capability and communicate with the sensors in accordance with a different communication protocol, preferably radio-based.

Of course, a proprietary communication method or communication protocol can also be used for the radio-based connection of the sensors, as is known, for example, from PCT/EP2014/053376, wherein its disclosure is included by reference with regard to the time-slot communication method described therein. However, in contrast to the system disclosed in PCT/EP2014/053376, this time-slot communication method is used here for communication between a sensor access point and a group of sensors assigned to this sensor access point. This proprietary communication method allowed extremely energy-saving operation of the sensors but at the expense of the availability of the sensors. The sensor rarely switches from its sleep mode to its active mode in order to be available in terms of radio technology. In this active mode, the sensor can also perform one or a plurality of detections. The collection data generated in the process can then be submitted over time using the proprietary communication method.

In order to ensure a higher availability of the sensors, the sensors can also be equipped with an additional wake-up receiver so that they can be activated by a wake-up signal emitted by a wake-up transmitter (possibly also addressed) in order to then carry out a detection in active mode but without being available on a radio-transmission level, thereby re-entering the energy-saving sleep mode until they are available again on a radio-transmission level in accordance with the time grid of the proprietary communication method. The wake-up signal has the effect of an external trigger signal to put the respective sensor into active mode.

Furthermore, regardless of the choice of communication method or the communication technology used in particular, the energy consumption of the sensor can be improved if the sensor is designed to only detect or measure at specific times.

In this way, the sensor can be designed to perform a measurement cyclically, particularly periodically, in accordance with a preferred embodiment type. For this purpose, it can comprise timer electronics. For example, the sensor can perform a detection every five minutes or every hour. Detections can also be carried out at non-periodic, i.e., unevenly long time intervals. For example, in the case of a product presentation device installed on business premises, it can be provided that its sensor(s) are designed to carry out detections or measurements every second during the time when there are typically many customers in the business premises, and to carry out such detections or measurements only every 15 minutes during those times when there are usually few customers in the business premises for example. In this way, changes can be periodically detected, for example, on a shelf. It is also possible for the detecting to take place at random intervals within a time range or spread over the opening hours of a business premises or spread over the day. For example, changes in a shelf that occur over a longer period of time can be detected without urgency but in an energy-saving manner.

The sensor can also be designed to receive a detection control signal in accordance with a preferred embodiment type and to perform a detection as a result.

Such a detection control signal can come from another sensor, for example. This can also be understood as a camera, a motion sensor or a temperature sensor that act as external triggers for the triggers of a detection process. These sensors do not necessarily all have to be installed on one and the same product presentation device. The detection control signal can also come from another, for example from a adjacent product presentation device. For example, the sensor can perform a detection when the detection control signal is generated and transmitted to a adjacent or logically linked sensor of another product presentation device. Conversely, such a sensor is designed to transmit a detection control signal to the adjacent or logically linked other sensors (be it a sensor on one and the same product presentation device or on another product presentation device). A trigger for this can be, for example, the detection of a removal or a change in the object stored in the storage structure in the sensor emitting the detection signal. The transmission of the detection control signal can take place directly via wired or radio-based communication between the sensors or via a higher-level administration instance.

The detection control signal can also be provided by a higher-level administration instance, such as a server or cloud-based software for example, detached from the scenario described earlier.

It can also be provided that the cyclic, the non-cyclic and the detections according to a detection control signal are available in a common embodiment variant.

In accordance with another aspect, the sensor can comprise a screen to display sensor identification data or product identification data or status information and the like.

The sensor identification data or product identification data can be represented, for example, by a number or an alphanumeric string, a barcode or a QR code (QR stands for Quick Response here). Sensor identification data allows the identification of a specific sensor and/or product presentation device.

Product identification data allows the identification of a product. In general, it should be mentioned here that a product can be placed distributed in a plurality of product presentation devices. The product identification data can also be used to easily query the inventory.

An additional external device or also an application installed on a mobile phone, for example, can be used to query the sensor identification data or product identification data. By scanning the barcode, QR code or number using the external device or mobile phone, or by entering the number into the external device or mobile phone, information about the product presentation device or sensor, such as battery level, when batteries are used, or the strength of the radio signal but also the distance detected, and the inventory of objects determined from it can be determined. In particular, it can be determined to which product the sensor in question is assigned. This query can also be carried out with the help of near-field communication (abbreviated NFC) if the sensor and the interrogating device are designed for it.

The sensor or its sensor identification data can be linked to a product or its product identification data in a database in such a way that the query can be used to find out whether the product in question is in the correct product presentation device.

The screen can be realized as an LCD screen or as an energy-saving “e-paper” screen, etc.

Furthermore, in accordance with a preferred embodiment type, the sensor can comprise an input unit, in particular, a button, for triggering a sensor function, preferably a product query, being particularly preferred, a real-time inventory query.

Such an input unit can be a switch, a lever or a button, particularly a button. The input unit can also be implemented as a “contactless” button, which can be realized by said NFC functionality.

In the simplest case, the sensor function to be triggered can be the triggering of a detection process by the sensor.

If the sensor is also equipped with a temperature sensor or its own temperature sensor, the sensor function can be, for example, a temperature query so that it is easy to check whether the temperature of the product presentation device is appropriate for the object in question. However, the temperature sensor can also be implemented separately from the sensor and transmit its data to the sensor.

The sensor function can also be a product or product status query so that a described product query can be carried out by pressing the input unit. In addition to information such as the product identification data, the exact designation, as well as a possible description of the product and any additional information, the product identification data can, in particular, contain information on the inventory so that real-time information on the inventory is conveyed or a real-time query of the inventory is made possible.

The requested data can be transmitted to the external device or mobile phone. Alternatively, the data can also be displayed on the screen if it is available and designed for this purpose. This information can also be transmitted to another device, for example to an Electronic Shelf Label, or ESL for short, and displayed by it.

For the product presentation device which, in accordance with the embodiment type a), has been shown to comprise a sensor movement system, it has proven to be particularly favourable if this sensor movement system comprises at least one of the following embodiments, namely: a draw-wire-based sensor movement system, a belt-based sensor movement system, a gear- or shelf-based sensor movement system, a thread-based sensor movement system, or a magnet-based sensor movement system.

These embodiment types can also occur in combination. For example, a draw-wire-based sensor system or a belt-based sensor movement system can handle the horizontal movement or positioning of the sensor while a thread-based sensor movement system handles the vertical movement or positioning of the sensor respectively.

Also, the sensor movement system can be designed to move a vertical row of sensors horizontally in the product presentation device. Alternatively, the sensor movement system can be designed to move a horizontal row of sensors vertically in the product presentation device.

Preferably, the sensor movement system is designed in such a way that the movement of the sensor along the rear edge of the storage structure is given by a linear motion or a rotational motion or a superposition of a linear with a rotational motion.

The sensor movement system allows the movement of a single sensor or a group of sensors, thereby extending the detection area of the individual sensor or group of sensors by means of a local offset.

A sensor movement system provides a range of motion for the sensor(s). Within this range of motion, those positions from which the objects are detected can essentially be traversed continuously. Thereby, for example, even with smaller objects or even bulk material, the distances between the objects and the sensor can be detected at different points. From this detecting data, the approximate quantity can be estimated or calculated back even in the case of small objects.

In many cases, however, particularly if the objects are arranged in a linear manner in the direction from the rear edge to the front edge of the storage structure, exactly one distance from the rearmost object to the sensor, i.e., near the sensor, is interesting. In contrast to the quasi-continuous motion mentioned above, it can be favourable in such discrete, linear delegations if the sensor movement system essentially moves the sensor(s) step by step from one detection position to the next detection position, i.e., moving them between the discrete detection positions as quickly as possible.

In this case, it has proven to be particularly favourable if the sensor movement system is designed in such a way that the sensor can be positioned in discrete positions.

This can be implemented, for example, via the control system or by means of a corresponding mechanical or also an electro-magnetic embodiment of the sensor movement system.

If, for example, a plurality of objects are placed in a line (arrangement line) from back to front in the storage structure, the distance of the rearmost object to the sensor, if the sensor is in the specified line, indicates a measure that allows conclusions to be drawn about the maximum number of objects in the storage structure. This is particularly true if the objects arranged in line have a cylindrical shape and the cylinder axis runs normally on the line of arrangement of the objects, as is the case with beverage cans arranged one behind the other. The distances that would be measured in the immediate vicinity of the objects or immediately adjacent to their line of arrangement are not particularly interesting and provide data that in many cases interfere because there is no use for them, and they only unnecessarily load the communication network or the radio network, as well as unnecessarily burden the power supply of the sensor.

A sensor movement system that positions the sensor in discrete positions, such as corresponding to the aforementioned alignment line, thus contributes not only to the optimization of energy consumption but also to the minimization of data volume and thus to the efficient use of the communication medium.

A special embodiment type of the sensor movement system comprises a first magnetic component, which is designed to be moveable with the sensor, and a second magnetic component, which is designed to be immoveable relative to the storage structure, and wherein at least one of the magnetic components is designed as a switchable electromagnet.

This allows the sensor movement system to be implemented in a very space-saving manner and with few or no moving components. By simply changing the pole of the electromagnet(s), forces are generated that allow the sensor to be moved or displaced along a rail that comprises isolated magnets. This can be facilitated by the fact that the housing comprises an essentially flat outer shell, which prevents the sensor from tilting due to magnetic force and simultaneously allows it to slip along.

However, the housing, particularly its faces, and the arrangement of the magnets along the circumference of the housing can also be designed in such a way that the sensor tilts from one housing surface to the next under the action of magnetic force and is thus moved further. Of course, the housing can also be designed on the circumferential side in such a way that an angular segment by angle rolls along the rear edge of the storage structure under the influence of magnetic force. For this purpose, individual magnets can be positioned along the round circumference of the housing in the centre of the angular segments. The individually switchable electromagnets are then installed along a rail, with the help of which the rolling movement is initiated and the direction of the rolling movement can be defined.

The sensor can also be located on or in a motion element. In this embodiment type, the magnetic components move the motion element that carries the sensor. Such a motion element does not have to be round or symmetrical, wherein round designs are suitable for continuous detection while non-round embodiments are suitable for detection at discrete positions. For example, the motion element can essentially be formed as a convex polygon.

In principle, the product presentation device can be implemented without a product guidance structure. In this case, however, the distance between an object and the sensor detected by the sensor only indicates an indication of the (presumed) maximum quantity of objects in the product presentation device, because only the object that is closest to the sensor can be detected. Whether further objects are now arranged in the direction of the front edge remains open. Incidentally, this is independent of whether the products are positioned in the aforementioned arrangement line or are also positioned in groups or even individually distributed on the storage structure.

It is therefore favourable to provide a product guidance structure that guides the product or products in such a way that the distance detected by the sensor gives a more accurate indication of the amount of objects on the storage structure. If, for example, the product guidance structure guides the objects in such a way that they are positioned in a row in the detection area while in contact with each other, i.e., are arranged along the said line of arrangement, the number of objects can be calculated back or at least estimated from the knowledge of the dimensions of the objects and the distance between the rearmost object and the sensor.

Therefore, in accordance with a preferred embodiment type, the rear edge of the storage structure lies above the front edge of the storage structure in the direction of gravitational acceleration, wherein the product guidance structure comprises a boundary in the area of the front edge of the storage structure or the storage structure at its front edge.

In accordance with this embodiment type, the objects automatically arrange themselves from the boundary towards the rear edge, i.e., essentially in the direction of the sensor, due to gravity. If an object close to the boundary is removed, the objects behind it are guided through the product guidance structure in such a way that they move towards the vacated space. When an object is removed, the remaining objects slip, slide or roll.

Said boundary can be, for example, a simple shelf rail that can carry paper labels or electronic shelf signs, or also a video shelf rail that comprises a video playback screen along the front edge of the storage structure.

This space-saving product guidance structure has advantages both without as well as in combination with the sensor movement system because, in both cases, it is possible to draw more precise conclusions about the number or quantity of objects in the storage structure.

Furthermore, it has proven to be favourable if the product guidance structure is designed in such a way that a plurality of objects in a row can be placed and guided along a line (the assembly line) extending between the rear edge and the front edge of the storage structure. This embodiment can be based, for example, on guide bars or guide walls that run on both sides of the objects to be fed between the front and rear edges of the storage structure. Their distance can be slightly larger than the diameter or other relevant dimension of the objects to be carried.

When using permanently installed sensors in the area of the rear edge of the storage structure, they can be easily placed in such a way that the detection area of the sensor in its centre roughly follows this line of arrangement, i.e., essentially enveloping it so that the distance between the rearmost object and the sensor is essentially proportional to the number or quantity of objects in this line.

When using a sensor movement system, the same effect can be achieved if at least one sensor is placed in the appropriate position so that its detection area is aligned with respect to the line of arrangement as described.

It is therefore particularly favourable if the sensor movement system, as described above, is designed to position the sensor in discrete positions corresponding to the alignment lines.

Furthermore, the product guidance structure can be designed to move one or a plurality of objects towards the front edge of the storage structure.

For example, the product guidance structure can be designed to move the object(s) by means of a pusher plate or product movement spiral.

Such a pusher plate can also be designed, for example, to move objects to the front edge of the storage structure under the influence of gravity. However, in most cases, it is favourable if the product presentation device comprises a product guide drive that moves, for example, the pusher plate or the product movement spiral. This drive can be implemented with the aid of an electromotive element or also with the aid of an elastic element, such as a spring, which is tensioned, for example, when the storage structure is loaded with objects and partially relaxes after or during the removal of an object and moves the remaining objects towards the front edge of the storage structure.

In connection with the linear guidance of the objects, it has proven to be particularly favourable if the product guidance structure is formed by a guide shaft that is open adjacent to the rear edge of the storage structure.

In order to realize the opening adjacent to the rear edge of the storage structure, a wall of the guide shaft can be dispensed with locally or it can be selected so low that the detection area of the sensor essentially covers the inside of the guide shaft without being hindered. The guide shaft can also comprise a wall adjacent to the rear edge of the storage structure with a hole-like or aperture opening through which the sensor can “see” into the interior of the shaft.

The guide shaft can comprise further openings, such as a removal opening at the front edge. It could also be open or closed on the ceiling side.

Ultimately, it should be mentioned that the mentioned electronic devices naturally comprise electronics. The electronics can be discrete or constructed by integrated electronics, or also a combination of both. Microcomputers, microcontrollers, Application Specific Integrated Circuits (ASICs), possibly in combination with analogue or digital electronic peripherals, can also be used. Radios usually comprise an antenna configuration for transmitting and receiving radio signals as part of a transceiver module.

Preferably, the sensor is battery-operated.

These and other aspects of the invention result from the figures described below.

### BRIEF DESCRIPTION OF THE FIGURES

The invention is explained in more detail below with reference to the attached figures on the basis of exemplary embodiments, to which, however, the invention is not limited. Thereby, identical components in the various figures are provided with identical reference numbers. Schematically, the figures show:

FIG. 1 a sensor for use in a product presentation device according to the invention;

FIG. 2 a product presentation device according to the invention with a product guidance structure with horizontally fixed positioned sensors;

FIG. 3 another product presentation device without a product guidance structure but with a sensor movement system for vertical movement of a single sensor;

FIG. 4 another product presentation device according to the invention with a product guidance structure and a sensor movement system for vertical individual sensor movement;

FIG. 5 another product presentation device according to the invention with a product guidance structure and sensor movement system for both horizontal as well as vertical individual sensor movement;

FIG. 6 another product presentation device according to the invention with a product guidance structure and sensor movement system for horizontal movement of vertically fixed positioned sensors,

FIG. 7 another exemplary embodiment of the sensor movement system,

FIG. 8 another exemplary embodiment of the sensor movement system,

FIG. 9 another product presentation device according to the invention with a pusher.

### DESCRIPTION OF THE EXEMPLARY EMBODIMENTS

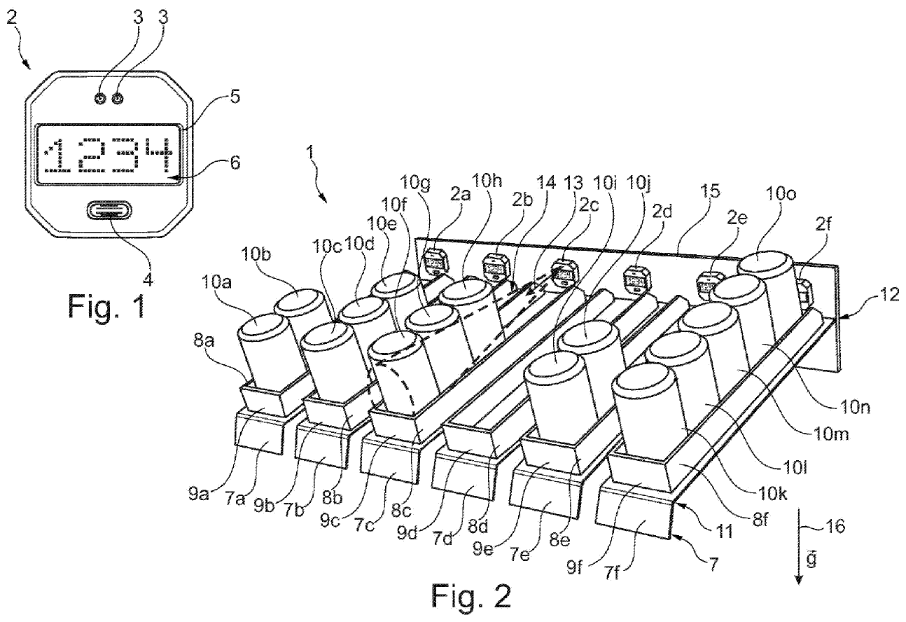

FIG. 1 shows a sensor 2 with sensor units 3, a button 4 and a screen 5.

The screen 5 is designed as an energy-saving e-paper display, but can also be implemented as an LCD screen, and displays sensor identification data in the form of a sensor ID 6, which allows users to draw conclusions about the MAC address (Media Access Control Address) of the sensor. For this purpose, the sensor ID 6 can, for example, be equal to the last characters of the MAC address or correspond to an identification number for which the corresponding MAC address is stored in a database.

The database can be accessed by means of a corresponding application on the user's mobile phone. The application also allows scanning of the sensor 2 with a camera of the mobile phone, wherein the sensor ID 6 is automatically detected by means of image recognition so that scanning or photographing is possible as an alternative to manually entering the code in order to query the data on the sensor and on a related product or a plurality of products. In particular, a real-time inventory query can be carried out, i.e., a query as to whether the corresponding product is still available in the warehouse or on another shelf.

For this purpose, the sensor 2 comprises a radio module (which is installed in the housing and is therefore not visible), which enables radio-based communication of the sensor 2. For example, the sensor 2 can use the radio module to transmit its detection data and product query requests and receive product information, particularly regarding the inventory.

As described in the general part of the description, radio communication can take place in a wide variety of ways. In the example given here, communication with an access point of a server is assumed.

Another way to use sensor functions and, in particular, to also start a product query is to press the button 4. This triggers a sensor function, wherein a request is sent to the access point, whereupon the corresponding data is sent to the sensor 2 and/or, where applicable, to the user's mobile phone. Thereby, when the user presses the button 4, the screen 5 changes its display and displays a number or string representing information about the product. For example, the display can show a number indicating the number of products available. By pressing the button 4 again, the position of the available products can be queried. A double press within a short period of time returns the sensor to normal display mode, in which it displays its sensor ID 6.

The sensor units 3 detect the presence of objects. Essentially, the distance between objects and the sensor 2 is determined. The sensor unit 3 can have to do with different sensor types. For example, it can have to do with ultrasound sensors, infrared distance sensors, cameras, or 3D cameras, but this list is not exhaustive. In the present case, however, it is assumed that sensor unit 3 is a time-of-flight sensor unit 3, in particular, a time-of-flight camera (TOF camera).

FIG. 2 shows a product presentation device 1 according to the invention with fixed sensors 2a-2f.

The sensors 2a-2f are attached to a rear wall 15.

In front of the rear wall 15 there is a storage structure 7, which is divided into six sections 7a-7f. The storage structure 7 or each section 7a-7f comprises a front edge 11 and a rear edge 12. At the rear edge 12, the storage structure 7 merges into the rear wall 15.

In the storage structure 7, there are objects 10a-10o, wherein objects 10a-10o are products. In the first section 7a, there are two objects 10a-10b. In the second section 7b, there are three objects 10c-10e. In the third section 7c, there are three objects 10f-10h. There is no object in the fourth section 7d. In the fifth section 7e, there are two objects 10i-10j. In the sixth section 7f, there are five objects 10k-10o.

The rear edge 12 of the storage structure 7 is located above the front edge 11 in the direction of gravitational acceleration, represented by the arrow 16. The bottom of the storage structure 7 is so smooth that objects placed on it 10a-12o automatically slide towards the front edge 11.

Each section 7a-7f comprises a product guidance structure 8a-8f. This product guidance structure 8a-8f guides the objects 10a-10o within a section 7a-7f each in a line, i.e., along an arrangement line.

The product guidance structure 8a-8f comprises a front boundary 9a-9f for each section 7a-7f to avoid objects 10a-10o falling out at the front edge 11. The boundary 9a-9f is so low that the foremost objects 10a, 10c, 10f, 10i and 10k, in particular, are clearly visible and can be easily removed after being lifted slightly. If one of these foremost objects 10a, 10c, 10f, 10i and 10k is removed, the object behind it slips down, i.e., towards the boundary 9a-9f.

Each of the sections 7a-7f is assigned a sensor 2a-2f.

Each sensor 2a-2f comprises a detection direction 13 that extends from the sensor to the respective objects 10a-10o in a section 7a-7f. As an example, the detection direction for the sensor 2c is shown as an arrow. The detection direction 13 of the sensor 2c thus points in the direction of the objects 10f-10h, which are located in the section 7c belonging to the sensor 2c.

A cone-shaped detection area 14 with a relatively small opening angle (small width of the opening angle) opens around the detection direction 13 starting from the respective sensor 2a-2f, wherein the opening angle is so small that the detection area 14 is limited to a single product guidance structure 8a-8f across the distance from the rear edge to the front edge. This detection area 14 is also shown as an example for the sensor 2c. The other sensors also comprise a detection direction 13 and a detection area 14.

In this exemplary embodiment, each sensor 2a-2f checks a group of objects 10a-10o, which are arranged in a line from the boundary 9a-9f to the sensor 2a-2f. Thereby, each sensor 2a-2f can detect or measure a distance that is representative of the number of objects 10a-10o in the respective section 7a-7f. Detection data generated by the sensor 2a-2f can be evaluated by the sensor 2a-2f itself or by a merchandise management system or, for example, also a mobile device (not shown). The length of the section 7c from the boundary 9c to the sensor 2c minus the distance of the rearmost object 10h to the sensor 2c, corresponds to the length occupied by the objects 10f-10h. This length divided by the respective dimension of the objects stored (e.g., in a database) 10f-10h (measured in the direction of detection), results in the number of objects 10f-10h in a section 7c. In the present case, the diameter of the cylindrical objects is used as a divisor.

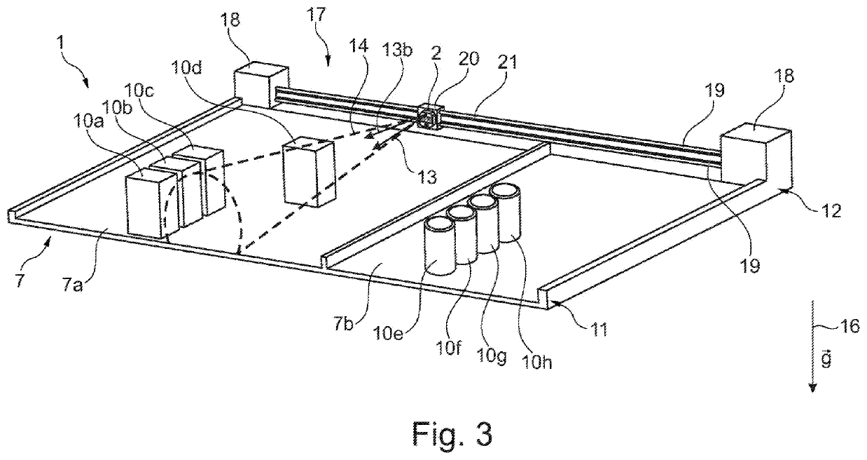

FIG. 3 shows an exemplary embodiment of a product presentation device 1 without product guidance structure 8a-8f.

In this exemplary embodiment, the rear wall 15 was also omitted to make room for a sensor movement system 17. Nevertheless, a wall can extend behind the sensor movement system 17, e.g., to separate two sides of the shelf from each other or to structurally delimit a shelf.

The sensor movement system 17 comprises two drive units 18 connected to two rails 19. A carriage 20 is mounted on the rails 19, which can be moved along the rails 19. The sensor 2 is mounted on the carriage 20. The carriage 20 is connected to a belt 21. The drive units 18 are designed to pull the belt 21 via at least one driven pulley inside at least one drive unit 18, thereby moving the carriage 20 and the sensor 2 along the rear edge 12. Thereby, the sensor movement system 17 is designed to move and position the sensor 2 horizontally with respect to gravitational acceleration, represented by arrow 16.

In front of the sensor movement system 17, there is the storage structure 7, which is divided into two sections 2a, 2b. The storage structure 7, or each section 7a, 7b, comprises the front edge 11 and the rear edge 12. The sensor movement system 17 is at the rear edge 12.

On the storage structure 7, there are also objects 10a-10h, wherein the objects 10a-10h are also products. In the first section 7a, there are four objects 10a-10d, wherein three objects 10a-10c stand in a row, while the fourth object 10d stands alone. In the second section 7b, there are four objects 10e-10h.

In this exemplary embodiment, the rear edge 12 of the storage structure 7 is aligned with the front edge 11 in relation to the direction of gravitational acceleration (represented by the arrow 16). Thus, in contrast to the exemplary embodiment described above, objects 10a-10f do not slide to the front edge 11 due to gravitational acceleration but remain in their respective positions until they are moved manually.

The detection direction 13 of the sensor 2 is parallel to the surface of the storage structure 7 and points from the sensor 2 to the front edge 11. However, it is also possible that the sensor 2 is designed to change the direction of detection 13 so that it does not have to be normally in the direction of movement of the sensor 2.

Here, too, the detection area 14 also extends in a conical shape around the detection direction 13.

For a cost-effective variant of this exemplary embodiment, the sensor 2 can be a simple time-of-flight sensor that detects or measures the distance from sensor 2 to the nearest object in the detection direction 13. If the sensor movement system 17 moves the sensor 2 along the rear edge 12, it can detect a plurality of areas, wherein conclusions can be drawn about the number of objects in the respective sections after subsequent evaluation of the detection results.

Thereby, it can be seen from the detecting data that in the second section 7b, the rearmost detected object 10h is placed in such a way that a maximum of four objects of the provided object type can be located in this section. In the first section 7a, two distances corresponding to objects 10c and 10d are detected. From the distance that was detected when the left object 10c was detected, it can be concluded or calculated that a maximum of three objects 10a-10c of the provided object type can be present. From the distance that was detected when the right object 10d was detected, it can be concluded or calculated that a maximum of five objects 10d of the provided object type can be present. Thus, in the first section 7a, there can be a maximum of eight objects 10a-10c. The fact that only two rows of objects 10a-10d were detected in the first section 7a and a row of objects 10e-10h in the second section 7b, and that these rows contain only a few objects even in the best case, can be interpreted by the merchandise management system as an indication that the objects 10a-10h are to be refilled. The sales staff can be informed about this by means of a mobile phone through the merchandise management system. As can be seen, this estimation gives a good guideline as to whether objects 10a-10h or products need to be gradually refilled, but this estimation does not agree with the actual number of objects 10a-10h.

In order to obtain a more accurate estimate of the number of objects, the sensor 2 can change the detection direction 13 by an angle, for example by 5° so that the new detection direction 13b is still parallel to the area of the storage structure 7. If the sensor 2 now moves a second time along the rear edge 12 and detects the respective distances, a more accurate number of objects can be calculated from the data of the two runs, because this can be used to determine whether or not there is another or also a plurality of objects between the front edge 11 and object 10d. Objects 10a and 10b located between the front edge 11 and object 10c can also be detected.

An even more accurate detection of the objects 10a-10h is possible if the sensor is a 3D camera, for example a TOF camera.

The movement of the sensor 2 is initiated by an electronic control system that is not shown further and which electronically controls the drive units 18.

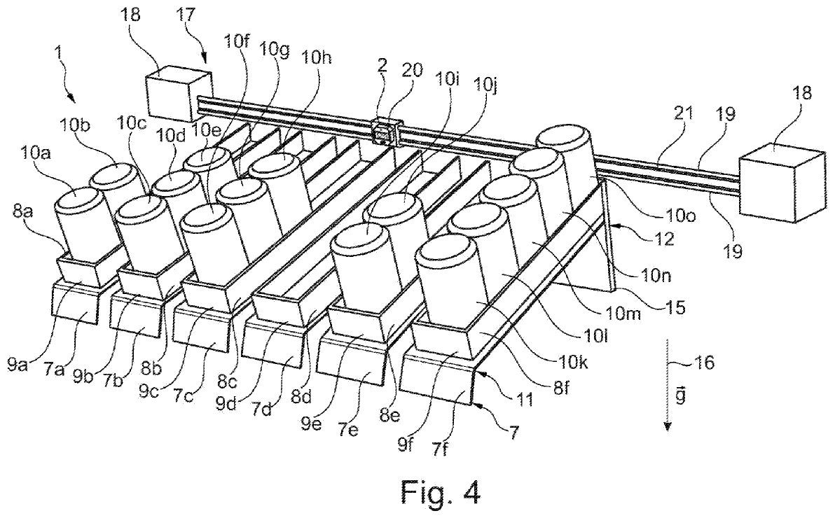

Furthermore, the accuracy of the estimation of the number of objects 10a-10h can be improved if, as described in the context of FIG. 2, a product guidance structure 8a-8f is provided. An exemplary embodiment having a combination of the product guidance structure 8a-8f and the sensor movement system 17 is shown in FIG. 4.

The storage structure 7 is in front of the sensor movement system 17. Above the rear edge 12, the rear wall 15, which is visible in FIG. 2, is missing in order to enable the sensor 2 to detect the objects 10a-10o that are located in the storage structure 7 in an undisturbed manner.

The storage structure 7, the rear wall 15 running below the rear edge 12 of the storage structure 7 and the drive units 18 can be permanently connected to a support structure not shown, such as a framework or other flat sheet metal parts or walls for example.

Here as well, the sensor is orientated in such a way that its detection direction 13, which is not shown in detail, points from the sensor 2 to the front edge 11 and runs parallel to the plane to the extension of the respective sections 7a-7f.

The sensor movement system 17, in particular the mentioned controller, is designed to move the sensor 2 into discrete positions. These discrete positions here are those in which the direction of detection and the line in which the objects 10a-10o are positioned coincide. Thereby, one detection is carried out for each section 7a-7f.

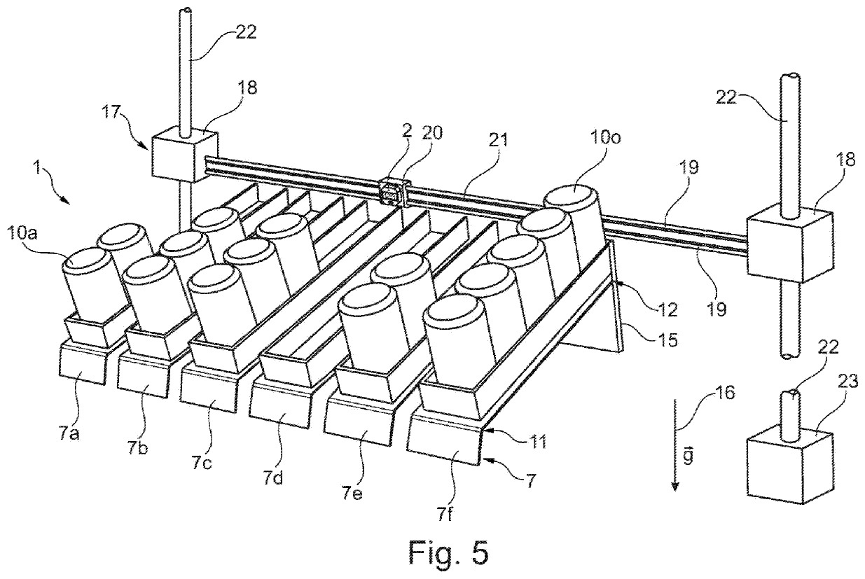

FIG. 5 shows another exemplary embodiment of product presentation device 1, wherein the sensor 2 can be moved not only horizontally but also vertically.

In this exemplary embodiment, the product presentation device 1 is a shelf that comprises a plurality of storage structures 7 that are arranged on top of each other, wherein only one is shown.

For the sake of clarity, the reference numbers have been reduced.

In contrast to FIG. 4, however, each of the two drive units 18 can be moved vertically and encloses a threaded rod 22 with an internal thread. Each threaded rod 22 is driven by a threaded rod drive unit 23. The threaded rod drive unit 23 is permanently connected to the support structure, which is also not shown here. It is therefore fixed relative to the rear wall 15.

The sensor movement system 17 or its threaded rod drive unit 23, controlled by the electronic control system, can therefore not only move the sensor 2 along the rear edge 12 of the displayed storage structure 7, but also move it in planes above or below the displayed storage structure 7. The sensor 2 can therefore detect not only a plurality of sections 7a-7f of a storage structure 7, but also a plurality of storage structures 7, i.e., an entire shelf.

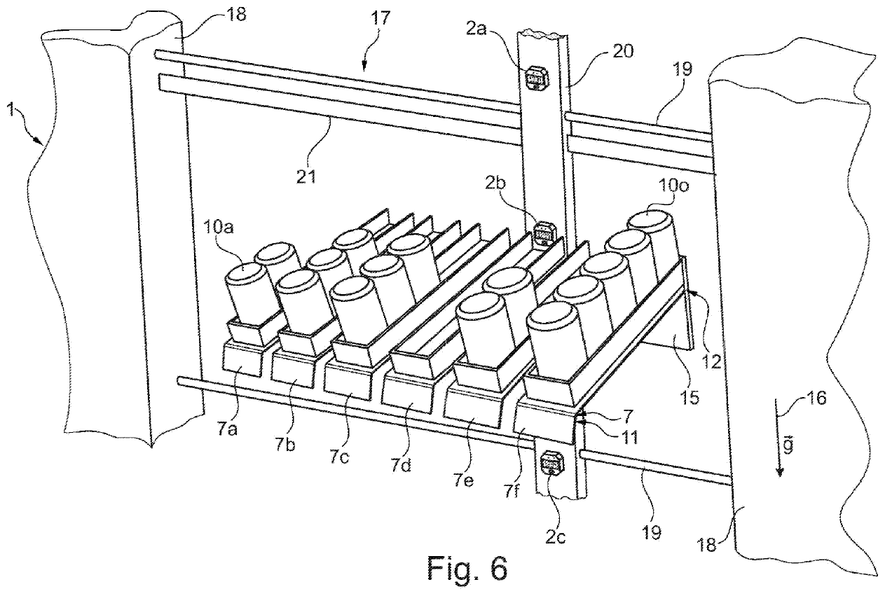

FIG. 6 shows another exemplary embodiment of a sensor movement system 17 for detecting a plurality of stacked storage structures 7. For this purpose, a plurality of sensors 2a-2c on a carriage 20 are provided here, wherein each sensor 2a-2c is assigned to one of the storage structure 7. The carriage 20 travels on the two rails 19 along the rear edge 12 of the storage structures 7. The drive units 18 as well as the rear wall 15 are permanently connected to the support structure. The drive units 18 are designed to move the carriage 20 over the belt 21. The middle sensor 2b is assigned to the displayed storage structure 7, which results from its horizontal positioning. The upper sensor 2a and the lower sensor 2c are each assigned to other storage structures 7 not shown here, which results from their individual horizontal location.

If the carriage 20 moves horizontally along the storage structures 7, each sensor detects the objects 10a-10o in the respective storage structures 7.

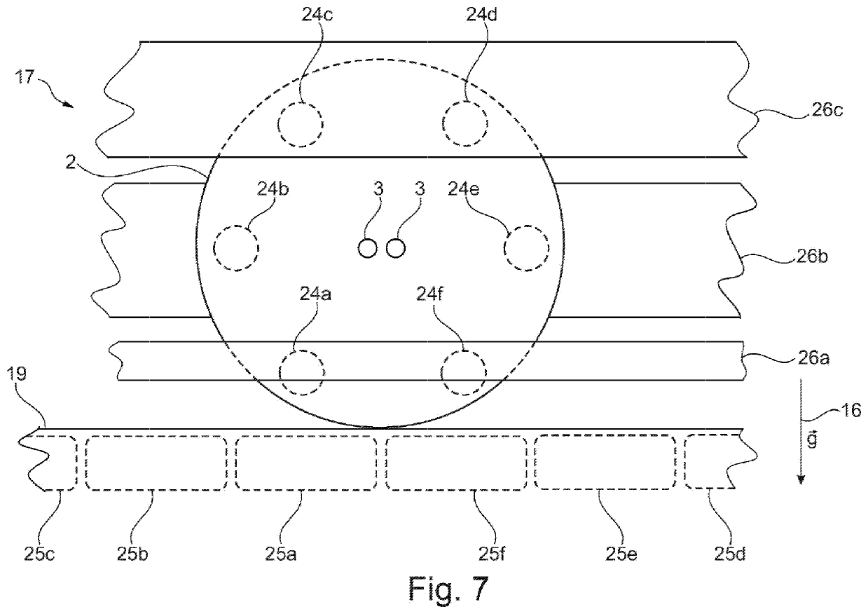

FIG. 7 shows a very space-saving exemplary embodiment for the sensor movement system 17 and for the sensor 2. The sensor 2 is designed as a cylindrical drive wheel. The sensor units 3 are placed close to the centre of the sensor 2. The sensor 2 is located on a rail 19 and is designed to roll on it. The sensor movement system 17 also comprises three bars 26a, 26b and 26c, which are designed to hold the sensor 2 on the rail 19. For this purpose, the lower bar 26a and the upper bar 26c are located on the side of the sensor 2 where the detection area 14 is located, while the middle bar 26b is located on the other side. This prevents the sensor 2 from falling off the rail 19.

The sensor 2 comprises six first magnetic elements 24a-24f, which are permanent magnets.

The rail 19 comprises a plurality of second magnetic elements 25a-25f along its entire length, which are electromagnets that can be switched on and off individually.

In the position shown, the two middle second magnetic elements 25a and 25f are switched in such a way that they pull the corresponding first magnetic elements 24a and 24f towards them.

In order to move the sensor 2 further to the right, i.e., to rotate clockwise, the left of the two active second magnetic elements 25a is deactivated and the next right second magnetic element 25e is activated so that the corresponding first magnetic element 24e is pulled down to the rail 19. In addition, the previously active second magnetic element 25a can be activated simultaneously reversed polarity in order to push the corresponding first magnetic element 24a away from the rail 19.

Alternatively, the first magnetic element 24a-24f can be designed as a ferromagnetic magnetic element.

It is also possible that the first magnetic elements 24a-24f are switchable electromagnets. Accordingly, the second magnetic elements 25a-25b can be permanent magnets or ferromagnetic magnetic elements. The rail 19 can also be made of a corresponding material.

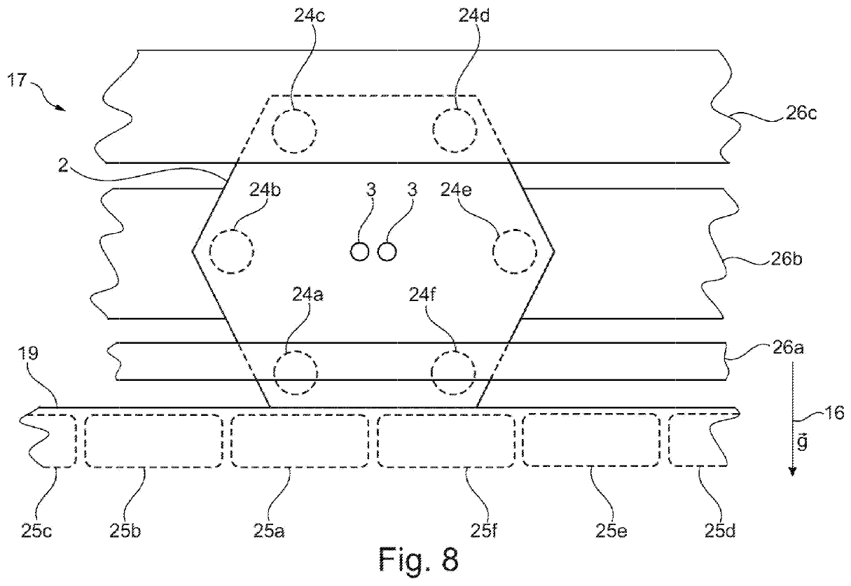

FIG. 8 shows another exemplary embodiment, wherein, in contrast to the embodiment shown in FIG. 7, the drive wheel is polygon-shaped in FIG. 8. This means that those surfaces on which the sensor 2 is in stable positions form essentially a convex polygon in the cross-section normally on these surfaces.

This gives the sensor 2 a secure hold at a desired position even when the electromagnets are not activated.

Furthermore, the sensor 2 can be positioned in specific, discrete positions. The layout of the storage structure 7 can therefore be adapted to the dimensions of the sensor 2 in such a way that sensor 2 can be placed in the desired discrete positions.

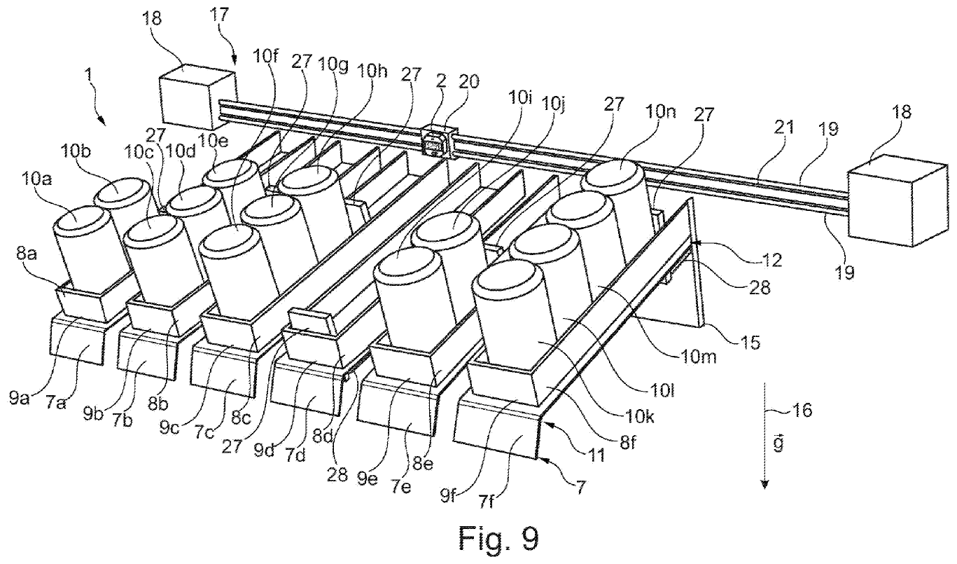

FIG. 9 shows another exemplary embodiment of product presentation device 1, which is largely similar to that in FIG. 4. However, in contrast to FIG. 4, the product guidance structure 8a-8f here comprises plate-shaped pushers 27 which are provided to push objects 10a-10n placed in the storage structure 7 or its sections 7a-7f to the front edge 11. For this purpose, each pusher 27 is connected to a spring element 28, which pushes the respective pusher 27 away from the rear wall 15 or pushes it towards the front edge 11.

In contrast to FIG. 4, the sensor 2 does not directly detect the distance between the sensor 2 and object 10a-10n but directly detects the distance between the sensor 2 and the pusher 27. Because the dimensions of the pushers 27 are known, it is easy to calculate back to the distance from the sensor 2 to the nearest object 10a-10n of the respective section 7a-7f.

At this point, it should also be mentioned that sections 7a-7f do not have to be separate from each other. Rather, they can also be designed as a contiguous level or assembly.

Finally, it is pointed out once again that the figures described in detail above are only exemplary embodiments, which can be modified by the person skilled in the art in various ways without leaving the field of the invention. For the sake of completeness, it is also pointed out that the use of the indefinite article “a” does not exclude that the respective features can also be present a multiple of times.

1. Product presentation device (1) comprising:
at least one sensor (2) with a detection area (14) for detecting an object (10a-10o) within the detection area (14), in particular, by measuring the distance between the sensor (2) and the object (10a-10o), and
at least one storage structure (7) for the storage of the object (10a-10o), wherein the storage structure (7) comprises a rear edge (12) and a front edge (11), wherein the detection area (14) of the sensor (2) is orientated along the direction from the rear edge (12) to the front edge (11), wherein,
either a sensor movement system (17) is provided by means of which a sensor (2) can be moved along the rear edge (12) in accordance with an embodiment type a);
or in accordance with an embodiment type b), individually positioned sensors (2) are provided along the rear edge (12) and a product guidance structure (8a-8f) is provided corresponding to the position of the respective sensor (2), which is provided for guiding the object (10a-10o) towards the front edge (11),
wherein the product guidance structure (8a-8f) is designed in such a way that:
either the product guidance structure (8a-8f) can be directly detected by the respective sensor (2)
or the direct detection of the guided object (10a-10o) by the sensor (2) is made possible,
or, in accordance with an embodiment type c), a sensor movement system (17) is provided by means of which a sensor (2) can be moved along the rear edge (12) and a product guidance structure (8a-8f) is provided which is provided for guiding the object (10a-10o) towards the front edge (11),
wherein the product guidance structure (8a-8f) is designed in such a way that:
either the product guidance structure (8a-8f) can be directly detected by the respective sensor (2)
or the direct detection of the guided object (10a-10o) by the sensor (2) is made possible,
or, in accordance with an embodiment type d), at least one sensor, or optionally, also at least one product guidance structure in accordance with the embodiment type c) is provided along the rear edge, wherein at least one sensor comprises a variable opening angle of its detection area.

2. Product presentation device (1) according to claim 1, wherein the storage structure (7) comprises a slope deviating from the horizontal, and the sensor (2) is orientated in such a way that its detection area (14) essentially follows the slope of the storage structure (7).

3. Product presentation device (1) according to claim 1, wherein the sensor (2) is designed for time-of-flight measurement.

4. Product presentation device (1) according to claim 1, wherein the sensor (2) is designed to transmit its detection data representing the detection of the object (10a-10o) in a radio-based manner.

5. Product presentation device (1) according to claim 1, wherein the sensor (2) is designed to perform cyclical detection.

6. Product presentation device (1) according to claim 1, wherein the sensor (2) is designed to receive a detection control signal and, as a result, to perform a detection based thereon.

7. Product presentation device (1) according to claim 1, wherein the sensor (2) comprises a screen (5) to display sensor identification data (6) or product identification data.

8. Product presentation device (1) according to claim 1, wherein the sensor (2) comprises an input unit (4), in particular, a button, for triggering a sensor function, preferably a product query, being particularly preferred, a real-time inventory query.

9. Product presentation device (1) claim 1 in accordance with embodiment type a) or c) of claim 1, wherein the sensor movement system (17) comprises at least one of the following embodiments, namely:
a draw-wire-based sensor movement system,
a belt-based sensor movement system
a gear- or shelf-based sensor movement system,
a thread-based sensor movement system,
a magnet-based sensor movement system.

10. Product presentation device (1) according to claim 9, wherein the sensor movement system (17) is designed in such a way that the movement of the sensor (2) along the rear edge (12) is provided by a linear motion or a rotational motion or a superposition of a linear with a rotational motion.

11. Product presentation device (1) according to claim 9, wherein the sensor movement system (17) is designed in such a way that the sensor (2) can be positioned at discrete positions.

12. Product presentation device (1) according to claim 1 in accordance with embodiment type b) or c) of claim 1, wherein the rear edge (12) of the storage structure (7) lies above the front edge (11) of the storage structure (7) in the direction of gravitational acceleration, wherein the product guidance structure (8a-8f) in the region of the front edge (11) of the storage structure (7) or the storage structure (7) comprises a boundary (9a-9f) at its front edge (11).

13. Product presentation device (1) according to claim 1 in accordance with embodiment type b) or c) of claim 1, wherein the product guidance structure (8a-8f) is formed in such a way that a plurality of objects (10a-10o) can be placed and guided one after the other along a line extending between the rear edge (12) and the front edge (11) of the storage structure (7).

14. Product presentation device (1) according to claim 1 in accordance with embodiment type b) or c) of claim 1, wherein the product guidance structure (8a-8f) is designed for moving one object (10a-10o) or a plurality of objects (10a-10o) towards the front edge (11) of the storage structure (7).

15. Product presentation device (1) according to claim 1 in accordance with embodiment type b) or c) of claim 1, wherein the product guidance structure (8a-8f) is formed by a guide shaft that is open adjacent to the rear edge (12) of the storage structure (7).
